(19) United States
(12) Patent Application Publication
(10) Pub. No.: US 2006/0158803 A1
(43) Pub. Date: Jul. 20, 2006

(54) Fault current limiters (fcl) with the cores staurated by superconducting coils

(75) Inventors: Alexander Friedman, Tel Aviv (IL); Moshe Zarudi, Tzfat (IL); Noam Shaked, Holon (IL); Shuki Wolfus, Kiriat-Ono (IL); Moshe Sinvani, Rishon Lezion (IL); Yosef Yeshurun, Ganei Tikvah (IL)

Correspondence Address: BROWDY AND NEIMARK, P.L.L.C.;624 NINTH STREET, NW, SUITE 300, WASHINGTON, DC, 20001-5303, US

(73) Assignee: Bar ILan University, Ramat Gan (IL)

(21) Appl. No.: 10/543,504

(22) PCT Filed: Jan. 27, 2004
(86) PCT No.: PCT/IL04/00073

§ 371 Date: Jul. 27, 2005

Related U.S. Application Data
(60) Provisional application No. 60/442,533, filed on Jan. 27, 2003.

(51) Int. Cl. H02H 9/00

(52) U.S. Cl. 361/58

(57) ABSTRACT

A superconducting short circuit current limiter (40a) for an alternating current system includes AC reactors having superconducting direct current bias windings (4a, 4b) that at normal conditions maintain the reactor's cores in saturated state. There are at least two AC coils (3a, 3b) for each phase operating at opposite half periods or at both half periods. The reactor may also have an additional feedback coil (42a, 42b) that at least partly compensates for the bias field of the superconducting coil at fault conditions enhancing a limiting capacity of the reactor. The reactor's core can be configured for decreasing its dimensions and mass as compared with known devices and for decreasing core losses. High voltage/high current devices include several standard modules connected in series or/and in parallel. A positional relationship of the modules is defined for decreasing necessary numbers of Amp?re-turns of superconducting and non-superconducting coils.

### FIELD OF THE INVENTION

This invention relates to current limiting devices for AC electric grid.

### REFERENCES

In the following description, reference will be made to the following non-patent publications:
[1] B. P. Raju, K. C. Parton, T. C. Bartram, “A current limiting device using superconducting d.c. bias: applications and prospects,” IEEE Transactions on Power Apparatus & Systems, vol. 101, pp.3173-3177, 1982.
[2] J. X. Jin, S. X. Dou., C. Grantham, and D. Sutanto “Operating principle of a high T-c superconducting saturable magnetic core fault current limiter”. Physica C, 282, Part 4: p. 2643-2644, 1997.
[3] J. X. Jin, S. X. Dou., C. Cook, C. Grantham, M. Apperley, and T. Beals, “Magnetic saturable reactor type HTS fault current limiter for electrical application”. Physica C, 2000.341-348: p.2629-2630.
[4] V. Keilin, I. Kovalev, S. Kruglov, V. Stepanov, I. Shugaev, V. Shcherbakov, I.Akimov, D. Rakov, and A. Shikov, “Model of HTS three-phase saturated core fault current limiter”, IEEE Transactions on Applied Superconductivity, vol.10, pp. 836-839, 2000.
[5] R. F. Giese, “Fault-current limiters—A second look,” Argonne Nat. Lab., Argonne, USA Mar. 16, 1995.

### BACKGROUND OF THE INVENTION

Fault current limiters (FCL) are expected to be among the first and most important power applications of high temperature superconductors (HTS). The advantages of HTS-FCL as compared to conventional circuit breakers, used world-wide in national electricity circuits, are their quick response and fast recovery, relatively low energy dissipation, tolerance to large fault currents and the possibility for virtually unlimited number of operations.

More particularly, the present invention relates to current limiting devices based on a superconducting coil with saturated core. Such a device comprises at least two coils with ferromagnetic cores for each phase connected in series with a load. On both cores there are superconducting bias coils connected to a DC power supply. At normal state the bias coils saturate the cores and the impedance of the current limiter is very low. When the load decreases, the current sharply increases and the cores are driven out of saturation at alternate half-cycles. As a result the impedance of the current limiter builds up and limits the increase of the current.

In U.S. Pat. No. 3,671,810 incorporated herein by reference this principle has been proposed for transient current limiting in electronic circuits. U.S. Pat. No. 4,045,823 incorporated herein by reference to K. C. Parton et al. describes a current limiting device for a power alternating current system. The current limiter has for each phase a pair of saturable reactors with the coils wound in opposite directions relative to superconducting bias coils. U.S. Pat. No. 4,117,524 incorporated herein by reference also to K. C. Parton et al. describes a modified form of current limiter having a screen of conductive material surrounding the bias winding to shield it against the alternating magnetic field. In this patent, one common bias coil is used for two reactors. Raju et al. [1] realize their current limiting device with a superconducting bias coil operating in a liquid helium bath and demonstrate its efficiency. U.S. Pat. No. 4,257,080 (Bartram et al.) incorporated herein by reference describes a further improvement of this current limiting device by placing the common bias coil on the central limbs of three or six cores of a three-phase reactor.

Several laboratory scale models of saturable core current limiters have been realized with superconducting coils made of high-temperature superconductors (HTS) [2, 3, 4]. These one-phase [2, 3] and three-phase [4] devices were built according the design proposed in the above-mentioned US Patents all of which are incorporated herein by reference.

The current limiter with saturated core has decisive advantages as compared with other superconducting current limiters:
its current limiting effect is not dependent on transition of the superconducting element to normal state, i.e. superconducting state is maintained all the time and no recovery time is necessary to return to ready state after fault. Moreover there is no dissipation of energy concerned with transition of the superconducting element to normal state;
the superconducting element is a coil made of standard superconducting wire manufactured on an industrial scale.
the superconducting coil operates in DC mode and is exposed to low AC magnetic fields.

The known designs of FCL with saturated core have the essential shortcomings that prevent the development and realization of this type of FCL. Its weakest points are the large weight and dimensions that are about twice the weight and dimensions of a transformer of the same power [5]. Also, in known FCLs of this type the impedance of the AC coils does not reach its maximum possible value because the bias coils produce the magnetic flux in the cores that reduces the impedance of AC coils. This feature is necessary at normal conditions but it has a negative effect at fault conditions. Furthermore, at fault conditions the alternating magnetic field of the AC coils affects the superconducting bias coil, decreasing its critical current. In known designs, a cryostat with bias coils is placed in the window of the core thus increasing its size.

A first objective of the present invention is to reduce the mass and dimensions of the ferromagnetic core of a current limiter having a saturated core, thereby reducing also the losses of the device.

A further objective of the present invention is to propose a new design of the current limiter with saturated core where the bias field is compensated fully or partially at the time of a fault.

Yet another objective of the present invention is to provide a modular design of current limiter with saturated core that can be manufactured at low cost.

Additional objectives of the present invention are:
to reduce the alternating magnetic field on the superconducting bias coils thus preventing a degradation of their critical current;
to propose a design that leaves sufficient room for the cryostat of the bias coils without increasing the core size; and
to ensure the possibility of adjusting the limited value of the fault current according to system requirements.

### SUMMARY OF THE INVENTION

These objects are realized in accordance with a first aspect of the invention by a current limiting device for an AC supply, said current limiting device comprising for each phase of the AC supply:

a magnetic core,

at least one superconducting bias coil for said magnetic core for biasing the core into saturation at normal conditions, and

two series-connected AC coils adapted to be connected in series with a load;

said magnetic core comprising a pair of elongated rod-shaped magnetic limbs, and

each of said AC coils being placed on a respective one of said limbs and being wound so as to produce magnetic fields of mutually opposing polarities so that in use during successive half cycles of the AC supply one of the AC coils produces a magnetic field that opposes a magnetic field of the bias coil.

There may also be optionally provided feedback coils that are energized at the moment of increasing voltage on the FCL and fully or partially compensate for the magnetizing effect of the bias coils, thus increasing effective permeability of the cores such that the impedance of the AC coils increases. The feedback coils can be energized, for example, from an independent DC power supply controlled by voltage drop on FCL or by a power supply connected in parallel to the FCL and including a step-down transformer and rectifier. In the latter case, the input voltage of the power supply is proportional to the voltage drop across the FCL. At normal operation, current in the feedback coils is very small and has no influence on FCL operation. At fault conditions, the current in the feedback coils increases to compensate for the magnetizing effect of the bias coils. It is important that the current in the feedback coils reaches the necessary threshold during the first half cycle after a fault event to decrease the initial rise in current. The feedback coils can be made of copper wire with relatively small cross-section because they operate for only short time (4-5 half-cycles) and the resulting heating is therefore small.

An additional effect of using the feedback coils consists (as a result of increasing the core permeability) in a strong reduction of the leakage AC field that has a negative influence on the superconducting bias coil.

The feedback coils allow the mass of the device to be reduced regardless of the type of core employed. To this end, in accordance with a second aspect of the invention, there is provided a current limiting device for an AC supply, said current limiting device comprising for each phase of the AC supply:

at least two series-connected AC coils adapted to be connected in series with a load, said coils being placed on respective limbs of at least one magnetic core, at least one superconducting bias coil for each magnetic core for biasing the core into saturation at normal conditions, and

at least one feedback coil for each bias coil for creating a magnetic flux that is dependent on a voltage drop across the current limiting device and in an opposite direction to a direction of a magnetic flux of the bias coil.

In accordance with another aspect of the invention, there is provided a method for reducing mass of a current limiting device for an AC supply, said current limiting device comprising for each phase of the AC supply:

a magnetic core,

at least one superconducting bias coil for said magnetic core for biasing the core into saturation at normal conditions, and

two series-connected AC coils adapted to be connected in series with a load; said method comprising:

(a) reducing a mass of the magnetic core by:
i) forming the magnetic core of a pair of elongated rod-shaped magnetic limbs;
ii) placing each of said AC coils on a respective one of said limbs; and
iii) configuring the AC coils so as to produce magnetic fields of mutually opposing polarities so that in use during successive half cycles of the

AC supply one of the AC coils produces a magnetic field that opposes a magnetic field of the bias coil; and/or

(b) reducing a mass of the AC coils by:
i) associating with the AC coils at least one feedback coil having a 5 magnetic flux that is in an opposite direction to respective magnetic fluxes of the bias coils for moving the core out of saturation thereby allowing the number of turns or the cross-sectional area of the AC coils to be reduced.

In order to decrease the weight and dimensions of the device, the ferromagnetic cores may have the form of elongated rods in contrast to the closed magnetic circuit in the known FCL. Thus the volume of the cores is approximately halved. At the same time the effective permeability of the rod is much less than the effective permeability of the closed magnetic circuit as illustrated by their Weber-Ampere characteristics. As a result, with the same parameters of the coil and the core cross-section, the maximal current of the current limiter with the rod core is larger. Thus the current limiter with the rod core should preferably operate so that the flux linkage does not surpass the upper knee of its Weber-Ampere characteristic thus reducing the effective impedance of the FCL. In contrast to the closed magnetic circuits, the properties of the rods are dependent on the positional relationship of the rods that has to be taken into account when designing the current limiter. By selection of the proper positional relationship of the rods, the necessary number of Ampere-turns of the AC coils and/or the bias coils and feedback coils may be decreased.

Another way of decreasing the weight and dimensions of the device is to use a combined structure in which the AC coils are located on two limbs of the elongated closed magnetic circuit. By such means, there is only one core instead of the two cores typically provided in known configurations. In the configuration according to the invention, the inductance of the two AC coils is about four times as large as the inductance of one coil because both AC coils are situated in a single magnetic circuit with additive polarity. This permits use of a core of smaller cross-section and/or fewer turns in the AC coils. Each bias coil and feedback coil encloses both long limbs of magnetic circuit. This arrangement ensures minimal AC magnetic field on the bias coil and minimal AC voltage on the bias coil and on the feedback coil because almost all the AC magnetic flux is enclosed within these coils. The AC field has a strong influence on the critical current of superconducting coils and for additionally decreasing this field a conductive and magnetic screen can be placed around the bias coil.

Introducing a small air gap in this closed elongated core configuration allows the FCL parameters to be adjustable. To decrease the number of Ampere-turns of the bias coil, two magnetic circuits having respective bias fields in opposite directions can be placed very close one to another thus decreasing the reluctance of the magnetic circuit of the bias coils.

The proposed designs according to the invention, both that having rod cores and that having combined closed cores, give the additional advantage of leaving sufficient space for disposition of cryostats with superconducting bias coils. These advantages are tangible regardless of whether the feedback coil is used as provided for by the invention. Thus operational performance of the FCL may be enhanced by using an additional feedback coil while physical size of the FCL may be reduced by the novel magnetic structure of the invention and these benefits can be used either singly or in combination.

A further realization of the invention is evident with the addition of a third central limb to the closed magnetic cores described above. The bias coil and the optional feedback coil are mounted on the said central limb. The two AC coils are placed on the outermost limbs. An additional advantage of this design as compared with those described above is the closed magnetic circuit of the bias coil and feedback coil that allows their Ampère-turns to be reduced in number.

According to a further embodiment of the present invention, in order to decrease manufacturing cost of the current limiter, it is assembled with standard modules that have the optimal size for the convenience of manufacturing and installation.

### BRIEF DESCRIPTION OF THE DRAWINGS

In order to understand the invention and to see how it may be carried out in practice, some preferred embodiments will now be described, by way of non-limiting example only, with reference to the accompanying drawings, in which:

FIG. 1 shows pictorially a prior art closed core configuration of a saturated core single phase FCL;

FIG. 2 is a schematic circuit diagram showing the prior art single phase FCL of FIG. 1 in use;

FIG. 3 shows linkage-current Ψ(I_{AC}) curves of the saturated core FCL shown in FIG. 1 with and without feedback coils;

FIGS. 4a, 4b and 4c show rod shaped cores for a single phase FCL according to different embodiments of the invention;

FIG. 5a, 5b, 5c and 5d show a saturated core FCL for a single phase with having a closed saturated core according to different embodiments.

FIG. 6 shows a saturated core FCL according to another embodiment of the invention having two AC coils on outermost limbs and bias and feedback coils on a central limb of a closed shell-type core; and

FIG. 7a is a schematic circuit diagram showing a single phase FCL according to the invention with independent power supply of the feedback coils;

FIG. 7b is a schematic circuit diagram showing a single phase FCL according to the invention with power supply of the feedback coils connected in parallel with the FCL.

### DETAILED DESCRIPTION OF THE INVENTION

In the following description various embodiments are described. To the extent that many features are common to different embodiments, identical reference numerals will be employed to refer to components that are common to more than one figure.

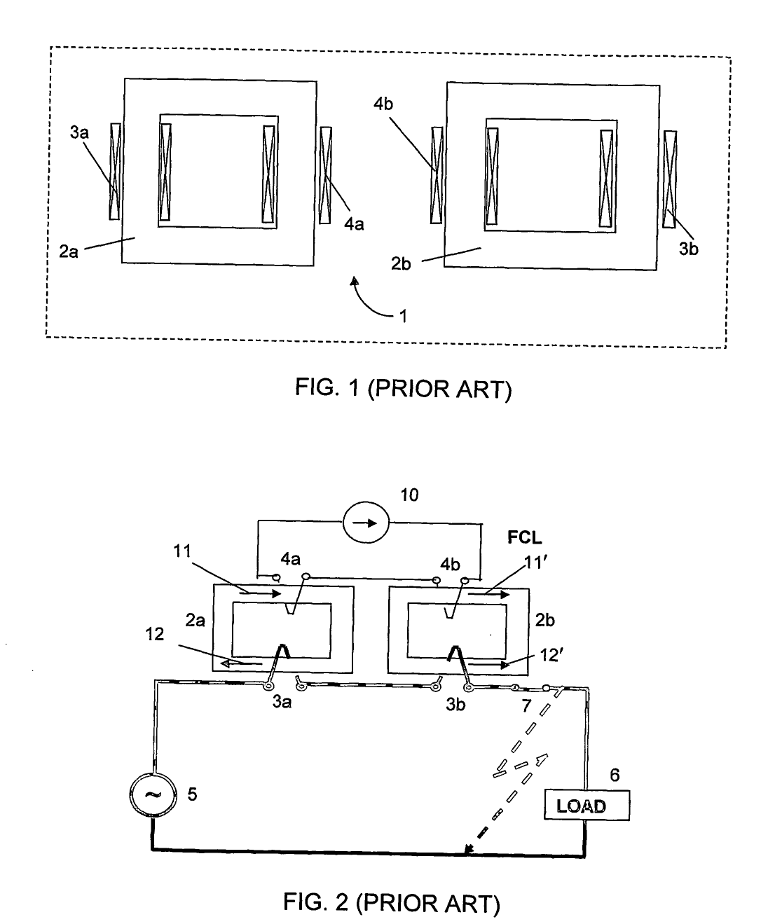

In order more fully to appreciate the benefit of the invention, it will be instructive first to consider a typical prior art single phase FCL. To this end, FIG. 1 shows pictorially a prior art saturated core single phase FCL designated generally as 1 having a pair of closed magnetic cores 2a and 2b each supporting a respective AC coil 3a and 3b. The cores further support a pair of DC superconducting bias coils 4a and 4b.

FIG. 2 shows schematically a circuit diagram showing the single phase FCL 1 in use. An AC supply 5, typically from the electric power grid, is connected to a load 6 via a circuit breaker 7. In series with the load 6 are connected the two AC coils 3a and 3b of the FCL. The respective superconducting bias coils 4a and 4b are connected to a DC power supply 10. At any moment the direction of the bias magnetic flux 11 in one core coincides with the direction of the magnetic flux 12 of AC coil whereas the direction of the bias magnetic flux 11′ in the other core is opposite to the direction of the magnetic flux 12′ of the AC coil. Under normal conditions, the bias coils 4a and 4b saturate the respective cores 2a and 2b. Under fault conditions, the AC coils 3a and 3b draw the respective cores 2a and 2b out of saturation during opposite half cycles of the AC cycle, thereby causing their average inductance to increase and thus limiting an increase of the current.

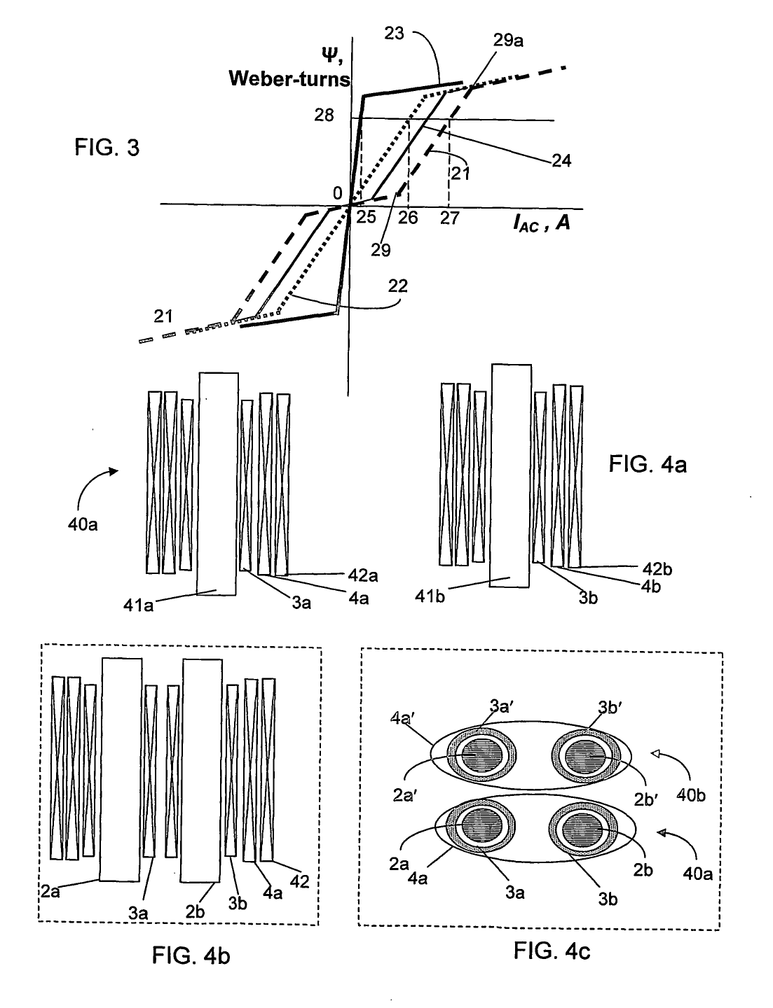

FIG. 3 shows graphically in curve 21 the linkage-current Ψ(I_{AC}) characteristic of the prior art saturated core FCL, shown in FIG. 1. The curves 22 and 23 shown alongside the curve 21 are corresponding flux linkage-current Ψ(I_{AC}) characteristics of a saturated core FCL according to the invention and are explained in greater detail below. The amplitude of magnetic flux linkage of the coil is proportional to the amplitude of the voltage drop on the FCL. When the flux linkage is below the lower knee 29 of the curve 21 the cores are saturated and the voltage drop across the FCL is small. At fault conditions, however, the voltage drop on the FCL can be close to the voltage of the grid and the current increases. But after the lower knee 29 on the curve 21 corresponding to an unsaturated core, the magnetic flux linkage rises more steeply for a given change in current since the FCL exhibits a larger average inductance that slows the current increase for a given change in voltage.

As noted above, one aspect of the invention is the use of feedback coils. FIG. 3 also shows the characteristic Ψ(I_{AC}) 22 of the core with the feedback coils, that fully compensate for the magnetic fluxes of the bias coils, intersects the point of origin and corresponds to the steep part only of the characteristic 21 of the core without the feedback coils. Thus the maximal current corresponding to a given flux linkage (and voltage) at fault conditions can be decreased. A given flux linkage 28 corresponds to a current magnitude 27 for the FCL without feedback coils and to a lesser current magnitude 26 for the FCL with feedback coils. When the flux created by the feedback coils is less than the flux of the bias coil, the characteristic Ψ(I_{AC}) 24 mediates and the average inductance of the AC coils has an intermediate value.

It will be understood from the foregoing that the use of feedback coils provides improved performance even when used with the prior art core shown in FIG. 1. Specifically, according to present invention the feedback coils can be used in any design of saturated core FCL.

The use of the feedback coils allows the magnetic core design to be changed such that the mass of the core decreases. The cancellation of the bias field during a fault increases the effective permeability of the magnetic core. As a result, the core cross section may be reduced as compared to an FCL with the same primary coil impedance and without feedback coil. Three different exemplary designs will now be described.

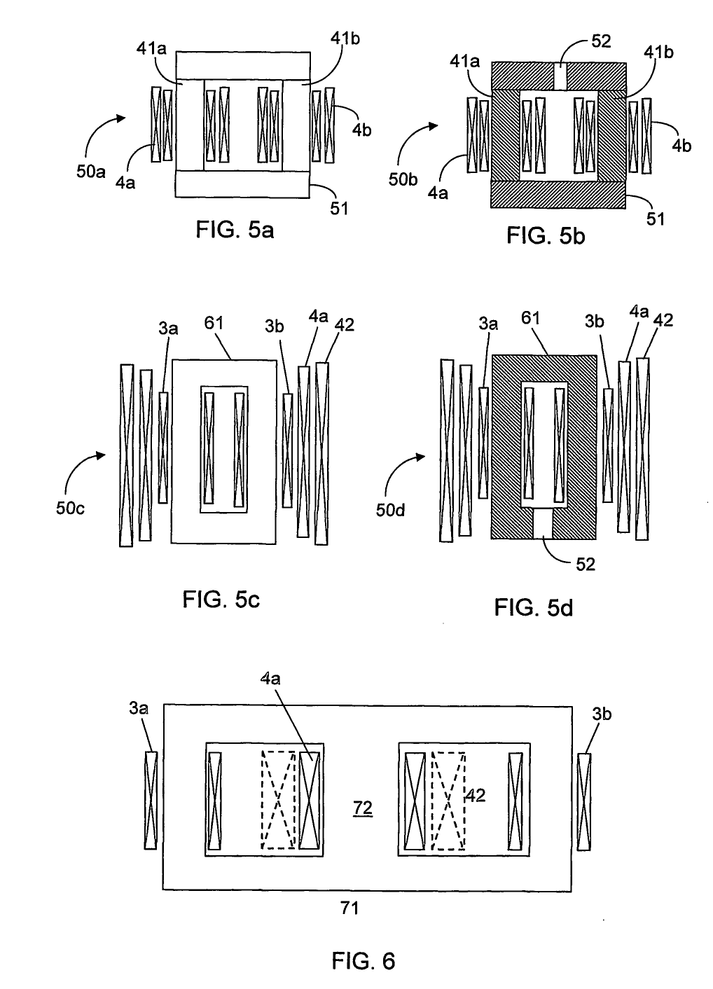

FIGS. 4a and 4b show a first design having two elongated rod-shaped cores 41a, 41b for a single phase instead of the two closed cores used in known designs (shown in FIG. 1). The volume of the rod-shaped cores is about half that of the closed cores shown in FIG. 1. The AC coil 3a, bias coil 4a and optionally a feedback coil 42a are mounted coaxially on the rod-shaped core 41a. In like manner, the AC coil 3b, bias coil 4b and optional feedback coil 42b are mounted coaxially on the rod-shaped core 41b. Separate bias coils may be used with a feedback coil on every core (as shown in FIG. 5a) or a common bias coil 4a and optional feedback coil 42 may be wound on both cores (as shown in FIG. 4b). Use of common bias coils has the advantage of smaller induced AC voltage across the bias coils as well as reduction of the mass of the core.

FIG. 4c shows schematically in plan view an assembly of two pairs of cores as shown in FIG. 4b that are juxtaposed so that the magnetic fields of adjacent bias coils are additive. For each pair of cores only the AC coils 3a, 3b and the bias coil 4a are shown. In the lower part of the figure (corresponding to the core shown in elevation in FIG. 4b), a single bias coil 4a encompasses both cores 2a and 2b. The upper part of the figure corresponds to another core matching the one shown in elevation in FIG. 4b and having similar reference numerals distinguished by the prime symbol (′). In this case also, a single bias coil 4a′ encompasses both cores 2a′ and 2b′. However, the magnetic flux of the two bias coils 4a and 4a′ are in opposite directions: one going into the paper and the other coming out of the paper so that the resulting magnetic forces are mutually attractive. The cores are shown by way of example with an open magnetic circuit, but a closed magnetic circuit may also be used.

FIGS. 5a and 5b show a second design of device shown as 50a and 50b respectively that includes for each phase at least one elongated closed core 50a having limbs 41a and 41b each supporting a respective AC coil. The limbs 41a and 41b are coupled at opposite ends by respective magnetic arms 51 thereby closing the magnetic circuit. In the device 50a the magnetic circuit is closed completely, while in the device 50b an air gap 52 is provided. By adjusting the thickness of the air gap 52, magnetic properties of the substantially closed core may be varied.

FIGS. 5c and 5d show devices 50c and 50d, respectively that are similar in arrangement to those shown in FIGS. 5a and 5b, respectively. However, whereas in the devices 50a and 50b shown in FIGS. 5a and 5b, separate AC and bias coils are wound around each limb 41a, 41b of the core, in the devices 50c and 50d separate AC coils 3a, 3b are wound around each limb 41a, 41b of the core but a single bias coil 4a is commonly wound around both limbs as is the optional feedback coil 42, thus further reducing the mass of the core.

Referring back to FIG. 3, the closed core has a much steeper Ψ(I_{AC}) characteristic 23 than an open core. This ensures a smaller current magnitude 25 or allows decreasing the cross-section of the core and/or number of Ampere-turns of the AC coils. The aiding connection of AC coils ensures about two times bigger inductance of both AC coils as compared with other designs because the AC coils have a common magnetic flux. The bias coil 3a and feedback coil 42 enclose both limbs of the core and surround both AC coils. Almost all the magnetic flux of the AC coils passes inside the core, thus the total alternating magnetic flux inside the bias and feedback coils almost vanishes and the AC voltage on these coils is very small.

FIG. 6 shows a third design that includes for each phase at least one shell-type core 71 with two AC coils 3a, 3b on the outermost limbs and a common bias coil 4a and an optional feedback coil 42 (shown dotted) placed on a central limb 72 of the core. Magnetically, the shell-type core 71 may be considered as a closed core as shown in FIG. 5a or 5c whose limbs 2a, 2b constitute the outermost limbs of the shell-type core 71 but having an extra limb in between the limbs 2a, 2b. This design has the same advantages as the previous design. The magnetic flux of the AC coils does not pass inside the central limb of the core and thus inside bias coil and feedback coil. Actually at normal conditions there is no induced AC voltage on the bias coils because the full AC magnetic flux inside the bias coil is zero. However, at fault conditions, the bias coil is exposed to alternating magnetic fields that decrease the critical current of the superconducting bias coil and degrade its performances. The coil design has to take into account the AC fields during fault time. A conductive electromagnetic screen may to be used to minimize these fields. The 3-phase FCL includes at least three identical elements, at least one element for each phase.

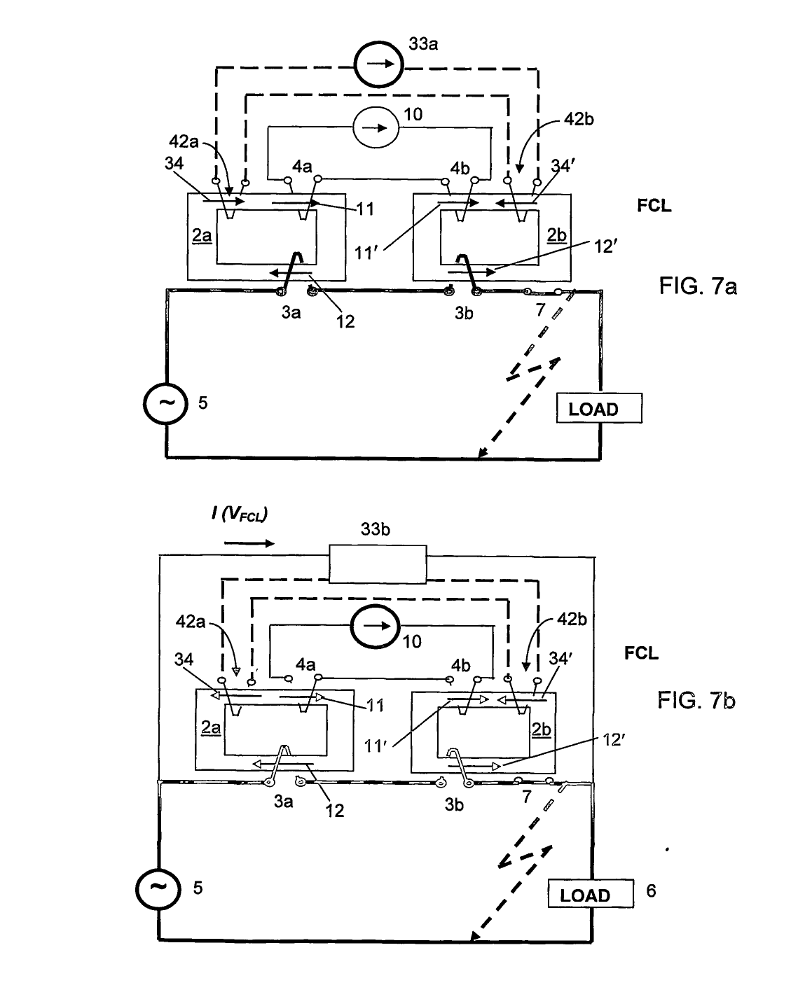

FIG. 7a is a schematic circuit diagram showing a FCL according to the first embodiment of the invention. It will be seen that the FCL includes all elements of the known FCL as described above with reference to FIG. 5a and in addition includes two feedback coils 42a and 42b energized by a DC power supply 33a. During a fault condition, the voltage drop across the AC coils 3a and 3b increases. The power supply is energized according to this voltage drop and thereby causes the current through the feedback coils also to increase. The magnetic flux 34 and 34′ created by the feedback coils is in the opposite direction to the respective magnetic fluxes 11 and 11′ of the bias coils 4a and 4b, and therefore moves the whole core out of saturation. In this condition both AC coils have high impedance during both halves of cycle. As a result, the voltage drop across each AC coil is only half of the voltage drop across the FCL. This allows the number of turns of the AC coils to be decreased. In this connection, it will be noted that the inductance is given by L˜μA N². The feedback increases μ thus allowing either A (core cross-section) or N (number of turns in the AC coil) to be reduced while maintaining the overall FCL impedance. Thus the feedback coil provides another way to achieve the objective of the invention of reducing core size. FIG. 7b shows schematically an FCL having the same components as shown in FIG. 7a but with power supply 33b of the feedback coils connected in parallel to the FCL or to the pair of its AC coils that are concerned with these feedback coils. In this case the feedback is realized directly. During a fault, a voltage drop on the FCL and thus on the power supply increases and results in increasing current in the feedback coils.

The invention also proposes an FCL assembly having a saturated core with standard elements (modules) of a size that allows building an FCL assembly with necessary parameters by connecting a required number of modules in series and/or in parallel. Each module is an FCL as described above with reference to FIGS. 4 to 6 of the drawings. When placing the modules together it is necessary to calculate the parameters of the FCL assembly taking into account a superposition of the magnetic fluxes of the adjacent modules. This superposition can ensure a smaller amount of Ampere-turns of bias coils and AC coils. Each module can have separate bias and feedback coils or the bias and feedback coils can be common for several modules. For example, as shown schematically in FIG. 4c two modules having closed cores can be placed one near the other in such a way that the magnetic fluxes of their bias coils have opposite directions. It will be understood that the bias coil has an open magnetic circuit in the elongated core configuration, so that placing two proximate modules in opposite directions has the effect of closing their magnetic circuit. In this case the reluctance of the magnetic circuit of these coils is smaller, and a smaller number of Ampere-turns is required.

According to another aspect of the invention any of the core designs described with reference to FIGS. 4 to 6 can be used in a saturated core FCL or in an FCL assembly comprising such FCL modules with or without feedback coils.

Example of FCL with 1 closed core for each phase

This FCL assembly example consists of modules that include for a single phase one closed saturated core having two AC-coils: one coil on each leg; bias coil and feedback coil are wound around the core with AC coils. It is used as a module in the 3-phase FCL assembly.

Parameters:

| | |
|---|---|
| Rated power | W = 1.67 MVA |
| Rated voltage | V = 3 kV |
| Rated current | I = 0.556 kA |
| Rated impedance | Z = 5.4 Ohm |
| Reactance at normal operation | X = 0.23 Ohm |
| Reactance at fault conditions | X = 2.2 Ohm |
| Steady state current at fault conditions | I_{SS} = 1.93 kA |
| Maximal fault current | I_{MAX} = 7 kA |

Dimensions and masses:

| | | |
|---|---|---|
| Height of the core | 3.15 | m |
| Diameter of the core | 0.18 | m |
| Mass of the core | 1.4 | tonne |
| Mass of the copper coils | 0.4 | tonne |
| Mass of the feedback coils | 0.06 | tonne |
| SC bias coil | 77 | kAmpère-turns |

3-phase FCL with 1 closed core for each phase

| | | | | |
|---|---|---|---|---|
| Rated power, MVA | 5 | 10 | 15 | 20 |
| Numbers of modules | 3 | 6 | 9 | 12 |
| Rated phase voltage, kV | 3 | 6 | 9 | 12 |
| Rated phase current, kA | 0.556 | 0.556 | 0.556 | 0.556 |
| Rated impedance, Ohm | 5.4 | 10.8 | 16.2 | 21.6 |
| Total mass of the cores, tonne | 4.2 | 8.4 | 12.6 | 16.8 |

1. A current limiting device for an AC supply, said current limiting device comprising for each phase of the AC supply:
a magnetic circuit,
at least one superconducting bias coil surrounding said magnetic circuit for biasing the magnetic circuit into saturation at normal conditions, and
two series-connected AC coils adapted to be connected in series with a load;
each of said AC coils being placed on a respective limbs of the magnetic circuit and being configured so as to produce magnetic fields of mutually opposing polarities so that in use during successive half cycles of the AC supply one of the AC coils produces a magnetic field that opposes a magnetic field of the bias coil; characterized in that:
said magnetic circuit comprises a pair of open elongated rod-shaped magnetic limbs.

2. The current limiting device according to claim 1, wherein the at least one superconducting bias coil comprises a single coil wound round both limbs of the magnetic circuit.

3. The current limiting device according to claim 1, wherein the at least one superconducting bias coil comprises a pair of coils each being wound round a respective limb of the magnetic circuit.

4. The current limiting device according to claim 1, wherein proximate ends of both limbs (41a, 41b) are magnetically coupled so as to close the magnetic circuit at each end of the limbs.

5. The current limiting device according to claim 4, wherein an air gap is formed in the magnetic circuit.

6. The current limiting device according to claim 1, further comprising at least one feedback coil for each bias coil for creating a magnetic flux that is dependent on a voltage drop across the current limiting device and in an opposite direction to a direction of a magnetic flux of the respective bias coil so as to put the magnetic circuit out of saturation thereby increasing the impedance of the magnetic circuit and decreasing the current through the current limiter.

7. The current limiting device according to claim 6, wherein the at least one feedback coil is supplied by an independent power supply providing a current having a magnitude that is controlled by a voltage drop on the device.

8. The current limiting device according to claim 6, wherein in use the at least one feedback coil is supplied by a rectified power supply connected in parallel with the current limiting device.

9. The current limiting device according to claim 4, wherein:
said pair of limbs form outermost limbs of a shell-type closed magnetic core further comprising a central limb that supports thereon a respective bias coil and
the central limb supports thereon a feedback coil.

10. The current limiting device according to claim 9 being a multi-phase FCL having at least two cores each in respect of a different phase, said current limiting device having a single bias coil common to at least two central limbs of respective cores of the magnetic circuit.

11. The current limiting device according to claim 10, further comprising a single feedback coil common to at least two central limbs of respective cores of the magnetic circuit.

12. The current limiting device according to claim 1, having at least one bias coil that is common to more than one limb of the magnetic circuit.

13. A current limiting assembly comprising at least two current limiting devices according to claim 1, each current limiting device having at least one respective bias coil.

14. The current limiting assembly according to claim 13, further including at least one respective feedback coil.

15. The current limiting assembly according to claim 13, comprising at least two current limiting devices or current limiting assemblies in series.

16. The current limiting assembly according to claim 13, comprising at least two current limiting devices or current limiting assemblies in parallel.

17. A current limiting assembly comprising at least two proximate current limiting devices according to claim 1, and configured such that the magnetic fluxes of the respective bias coils of adjacent devices are in mutually opposite directions.

18. A current limiting device for an AC supply, said current limiting device comprising for each phase of the AC supply:
at least two series-connected AC coils adapted to be connected in series with a load, said coils being placed on respective limbs of at least one magnetic circuit, at least one superconducting bias coil for each magnetic circuit for biasing the magnetic circuit into saturation at normal conditions, and at least one feedback coil for each bias coil for creating a magnetic flux that is dependent on a voltage drop across the current limiting device and in an opposite direction to a direction of a magnetic flux of the bias coil so as to put the magnetic circuit out of saturation thereby increasing the impedance of the magnetic circuit and decreasing the current through the current limiter.

19. The current limiting device according to claim 18, wherein the at least one super-conducting bias coil comprises a single bias coil commonly wound round the limbs of the magnetic circuit.

20. The current limiting device according to claim 18, wherein the at least one superconducting bias coil comprises a pair of bias coils each being wound round a respective limb of the magnetic circuit.

21. The current limiting device according to claim 18, wherein proximate ends of both limbs are magnetically coupled so as to close the magnetic circuit at each end of the core.

22. The current limiting device according to claim 21, wherein an air gap is formed in the magnetic circuit.

23. A method for reducing mass of a current limiting device for an AC supply, said current limiting device comprising for each phase of the AC supply:
a magnetic circuit,
at least one superconducting bias coil surrounding said magnetic circuit for biasing the magnetic circuit into saturation at normal conditions, and
two series-connected AC coils adapted to be connected in series with a load; said method comprising:
(a) reducing a mass of the magnetic circuit by:
i) forming the magnetic circuit of a pair of open elongated rod-shaped magnetic limbs;
ii) placing each of said AC coils on a respective one of said limbs; and
iii) configuring the AC coils so as to produce magnetic fields of mutually opposing polarities so that in use during successive half cycles of the AC supply one of the AC coils produces a magnetic field that opposes a magnetic field of the bias coil; and/or
(b) reducing a mass of the AC coils by:
i) associating with the AC coils at least one feedback coil having a magnetic flux that is in an opposite direction to respective magnetic fluxes of the bias coils for moving the magnetic circuit out of saturation thereby allowing the number of turns or the cross-sectional area of the AC coils to be reduced.
